(19) United States
(12) Patent Application Publication
(10) Pub. No.: US 2005/0011968 A1
(43) Pub. Date: Jan. 20, 2005

(54) Fluid control system for gas/liquid

(76) Inventors: James B.A. Tracey, Austin, TX (US); Jeffrey M. Harrington, Vancouver, WA (US); Martin Koebler, San Francisco, CA (US); Ramon Anthony Caamano, Gilroy, CA (US); Norbert Kozar, Redwood City, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/823,916

(22) Filed: Apr. 12, 2004

Related U.S. Application Data
(60) Provisional application No. 60/462,571, filed on Apr. 11, 2003.

(51) Int. Cl. B05B 7/04

(52) U.S. Cl. 239/195; 239/197; 239/433

(57) ABSTRACT

A fluid system has a fluid control device that can receive a gas hose and fluid hose. The fluid control device can also have a gas source and can be configured to receive the liquid hose. The fluid control device is provided to output a fluid flow into an output hose. The fluid control device can be positioned near a liquid source or a nozzle of the output hose. In another arrangement, the fluid control device can receive low pressure fluid and deliver high pressure fluid to a high pressure device. The fluid system can have a hose reel apparatus for spooling a hose connected to the fluid control device and the high pressure device.

### RELATED APPLICATIONS

This application relates to and claims the benefit of the provisional application 60/462,571 filed Apr. 11, 2003, which is hereby incorporated by reference in its entirety.

### BACKGROUND OF THE INVENTION

1. Field of the Invention

The present invention relates generally to fluid systems having hoses and particularly to controlling flow through those hoses.

2. Description of the Related Art

Pressure washers are commonly used for washing. Typically, a pressure washer has a nozzle attached to one end of a hose and the other end of the hose is attached to a liquid source that supplies a pressurized liquid, normally water. A user can adjust the nozzle to change the velocity of water flowing out of the nozzle. For example, a garden hose may be used for cleaning areas outside of a house. One end of the garden hose is fitted to a faucet (e.g., outside of the house), with a traditional manual spigot or valve for turning the water flow off or on. The other end of the garden hose may have a nozzle, such as a spray gun. The spray gun enables the user to adjust the water sprayed out of the nozzle. Unfortunately, the liquid source (e.g., a faucet) provides a liquid at a generally low pressure which may not be suitable for many sprayers, such a high pressure sprayers.

The liquid source also provides a liquid at a generally constant pressure, thereby limiting the output velocity of the water. Further, the user can not use this configuration to spray air because the typical garden hose configuration supplies only water. On the other hand, there are known devices that have an air source providing pressure for spraying a liquid. The air source may be a conventional air compressor which generates sufficient pressure to spray the liquid. Unfortunately, the user cannot use these sprayers to spray both air and a liquid.

Another approach for cleaning is to use an air hose with a nozzle attached to one end and a blower or air supply attached to the other. Normally, the air supply is an air compressor that provides pressurized air to the air hose. These air pressure devices are commonly used to blow debris in a desired direction. For example, wood or metal shops have these air pressure devices to blow wood chips or metal shavings off of equipment and into disposal systems. These air systems, however, do not supply any water.

Accordingly, there exists a need for an improved device for supplying a fluid.

### SUMMARY OF THE INVENTION

Accordingly, it is a principle object and advantage of the present invention to overcome some or all of these limitations and to provide a control device for providing a fluid and gas.

In one aspect, a hose system comprises a fluid control device and a hose reel device. The fluid control device comprises an inlet and an outlet. The fluid control device is configured to receive liquid at a first pressure through the inlet and to provide liquid at a second pressure through the outlet. The first pressure is less than the second pressure. The hose reel device is in fluid communication with the outlet of the fluid control device. The hose reel device comprises a rotatable drum onto which a hose can be spooled and is configured to convey fluid from the outlet to a hose spooled onto the drum.

In another aspect, a fluid control device for a pressure fluid system comprises a gas inlet, a liquid inlet, an outlet, and a valve system. The liquid inlet is configured to be coupled to a hose. The outlet is configured to be coupled to a hose. The valve system is configured to allow into the outlet a liquid flow from the liquid inlet while stopping a gas flow from the gas inlet. The valve system is configured to allow into the outlet the gas flow from the gas inlet while stopping the liquid flow from the liquid inlet. The valve system is configured to allow into the outlet a mixed flow comprising the liquid flow and the gas flow.

In another aspect, a method of providing fluid flow comprises receiving a liquid flow from a liquid inlet. A gas flow is received from a gas inlet. The liquid flow from the liquid inlet is conveyed into an output hose while preventing the gas flow from the gas inlet from flowing into the output hose. The gas flow from the gas inlet is conveyed into the output hose while preventing the liquid flow from the liquid inlet from flowing into the output hose. A mixed flow comprising the liquid flow and the gas flow is conveyed into the output hose.

In another aspect, a hose system comprises a fluid control device, an inlet hose, and an output hose. The fluid control device comprising an inlet and an outlet. The inlet hose is in fluid communication with the inlet, the inlet hose having an inlet hose lumen with a first cross sectional area. The output hose is in fluid communication with the outlet. The output hose has an output hose lumen with a second cross sectional area that is smaller than the first cross sectional area. The fluid control device is configured to receive liquid from the inlet at a first pressure and convey the liquid to the outlet at one of a second and a third pressure. The first pressure is less than the second and third pressures, and the second pressure is less than the third pressure. The second pressure is at about a level sufficient to induce a flow rate in the output hose that is generally equivalent to a flow rate of a similar liquid flowing at said first pressure in a lumen having said first cross sectional area. The third pressure is at least 500 psi. Optionally, the third pressure is at least 1200 psi. Alternatively, the third pressure is within 500-5000 psi. Alternatively, the third pressure is at least 2000 psi. Optionally, the first pressure is within 40-60 psi.

In another aspect, a fluid control device for a pressure fluid system comprises a gas inlet system, a liquid inlet system, an output hose, and a valve system. The valve system is located between the liquid inlet system and an outlet and between the gas inlet system and the same outlet. The valve system is configured to allow liquid flow from the liquid inlet system and gas flow from the gas inlet system into the outlet, separately or together. Preferably, the system is particularly configured to mate with hoses capable of operating at elevated pressures (preferably at least 1200-1500 psi) and can convert ordinary water flow from household taps into a power spray source, while also allowing use of the same system for blower and watering applications.

In another aspect, a fluid control device for a fluid system comprises a plurality of flow paths. The plurality of flow paths comprises a liquid flow path positioned between liquid inlet and an outlet, an air flow path between an air inlet and the same outlet, and a pressurized liquid flow path extending to the outlet. Further, a valve system is configured to selectively allow flow along one of the liquid flow path, air flow path, and pressurized liquid flow path.

In another aspect, a fluid control device for a pressure fluid system comprises a gas inlet, a liquid inlet, an outlet, and a valve system. The valve system is configured to allow into the outlet a liquid flow from the liquid inlet while stopping a gas flow from the gas inlet. The valve system is configured to allow into the outlet the gas flow from the gas inlet while stopping the liquid flow from the liquid inlet, the valve system configured to allow into the outlet a mixed flow comprising the liquid flow and the gas flow. In one arrangement, the fluid control device further comprises a gas inlet system comprising the gas inlet and a gas passage, a gas hose and the gas passage coupled to the gas inlet therebetween. In another arrangement, the fluid control further comprises a liquid inlet system comprising the liquid inlet and a liquid passage, a liquid hose and the liquid passage coupled to the liquid inlet therebetween and an output hose coupled to the outlet. In some embodiments the liquid inlet and the outlet are configured to couple with a conventional garden hose, while in other embodiments they are configured to couple with a hose capable of operating at elevated pressures (e.g., at least 1200-1500 psi). In another arrangement, the valve system is within a single housing, and the gas inlet, the liquid inlet, and the outlet are disposed on the housing and providing fluid communication with the valve system. In one arrangement, the valve system is configured to selectively provide the mixed flow ranging between mostly comprising the fluid flow and mostly comprising the gas flow. Preferably, the fluid flow is water and the gas flow is air.

In one aspect, a fluid control device for a pressure fluid system comprises a gas inlet system, a liquid inlet, an outlet, and a valve system. The valve system is configured to selectively provide one of a liquid flow from the liquid inlet, a gas flow from the gas inlet system, or a pressurized liquid. In one arrangement, the fluid control device further comprising a fluid mixing chamber in communication with the gas inlet system and the liquid inlet, the fluid mixing chamber configured to contain liquid and gas and feed the valve system the pressurized liquid. Preferably, the liquid inlet and outlet are on a device housing, and the valve system and the fluid mixing chamber located within the device housing. In one arrangement, the gas inlet system comprises a gas pressure device. In one embodiment, the gas inlet system includes an external air compressor and a gas inlet on a device housing. Alternatively, the gas inlet system includes an internal gas compressor and an air intake on a device housing.

In another aspect, a fluid control device for a pressure fluid system comprising a housing, an outlet on the housing, and a valve system. The valve system is in fluid communication with a gas source and a liquid source and provides a flow to the outlet. The valve system is capable of selectively switching the flow from among the liquid source, the gas source, and a pressurized liquid source. In one embodiment, the valve system and pressurized liquid source are within the housing

All of these aspects are intended to be within scope of the invention herein disclosed. These and other aspects of the present invention will become readily apparent to those skilled in the art from the appended claims and from the following detailed description of the preferred embodiments having reference to the attached figures, the invention not being limited to any particular preferred embodiment(s) disclosed.

### BRIEF DESCRIPTION OF THE DRAWINGS

These and other aspects of this invention will be readily apparent from the detailed description below and the appended drawings, which are meant to illustrate and not to limit the invention, and in which:

FIG. 1A is a schematic illustration of a hose system in accordance with one embodiment of the present invention.

FIG. 1B is a schematic cross-section of a fluid control device in accordance with one embodiment of the present invention.

FIG. 1C a schematic cross-section of a fluid control device in accordance with another embodiment of the present invention.

FIG. 1D is a schematic illustration of a valve system of a fluid control device in accordance with another embodiment of the present invention.

FIG. 2A is a schematic illustration of a hose system in accordance with another embodiment of the present invention, having a fluid control device in combination with a hose reel in accordance with the another embodiment of the present invention.

FIG. 2B is a schematic cross-section of a fluid control device in accordance with another embodiment of the present invention.

FIG. 3A is a schematic illustration of a hose system in accordance with another embodiment of the present invention.

FIG. 3B is a schematic cross section of a fluid control device in accordance with another embodiment of the present invention.

FIG. 3C is a schematic cross section of the valve system of the fluid control device of FIG. 3B, in accordance with one embodiment.

FIG. 4A is a schematic illustration of a hose system in accordance with another embodiment of the present invention.

FIG. 4B is an illustration of an integrated hose reel apparatus and fluid control device of FIG. 4A in accordance with one embodiment of the hose system.

FIG. 4C is a schematic cross section of one embodiment of the fluid control device of FIG. 4A.

FIG. 5A is a cross section view of one embodiment of a multi-lumen hose of the present invention.

FIG. 5B is a cross section view of another embodiment of a multi-lumen hose of the present invention.

FIG. 5C is a cross section view of another embodiment of a multi-lumen hose of the present invention.

FIG. 6A is a schematic cross section view of one embodiment of a nozzle of the present invention.

FIG. 6B is a schematic cross section view of another embodiment of a nozzle of the present invention.

FIG. 6C is a schematic cross section view of another embodiment of a nozzle of the present invention.

FIG. 6D is a schematic cross section view of another embodiment of a nozzle the present invention.

### DETAILED DESCRIPTION OF THE PREFERRED EMBODIMENT

While illustrated in the context of hoses for household applications, the skilled artisan will readily appreciate that the principles and advantages of the preferred embodiments are applicable to other types of hose products. To assist in the description of the components of the present invention, proximal and distal are used in reference to the upstream and downstream, respectively. That is, proximal locations are upstream from distal locations.

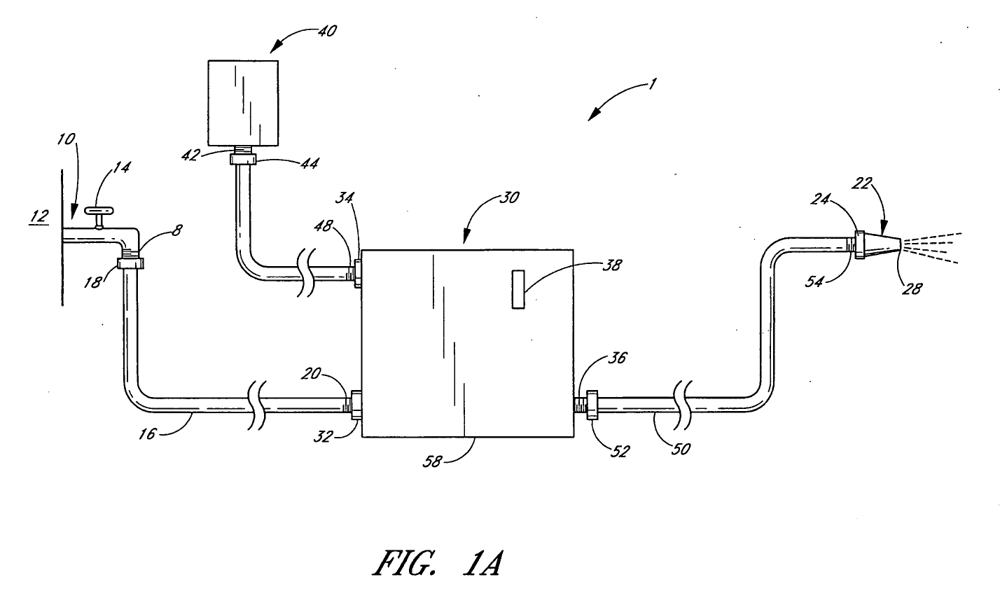

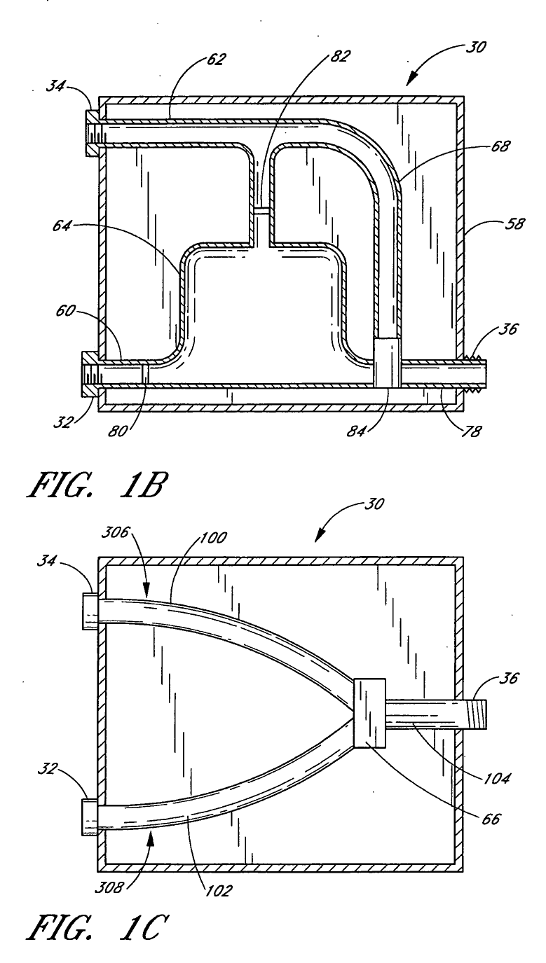

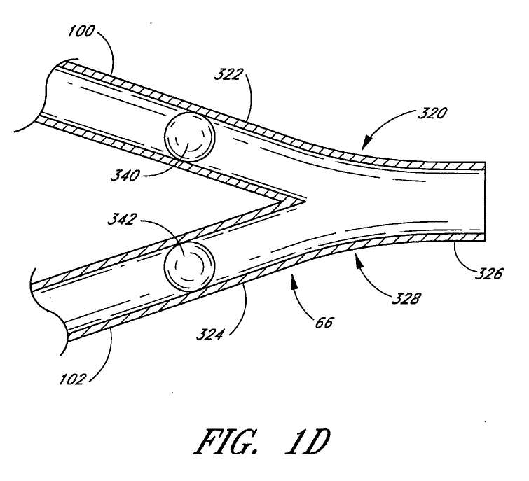

FIG. 1A is a schematic illustration of a hose system 1 in accordance with a preferred embodiment of the present invention. A fluid source is illustrated in the form of a liquid source, particularly a water faucet 10. A gas supply 40 is illustrated as an air source, such as an air compressor or blower, that provides pressurized gas to a gas hose 46. The water faucet 10 and gas supply 40 are in communication with a fluid control device 30. The fluid control device 30 is in communication with a nozzle 22.

The faucet 10 is illustrated as extending from the wall of a building 12 to an outlet 8. It will be understood that, in other arrangements, the faucet can extend from another building structure or the ground. The faucet 10 includes a valve or spigot with a manual control 14. The faucet outlet 8 is conventionally configured to receive a liquid or water hose 16. In the illustrated embodiment, the faucet outlet 8 is threadably coupled to a proximal end 18 of the liquid hose 16. The distal end 20 of the liquid hose 16 is conventionally configured and coupled to a liquid inlet 32 of the fluid control device 30. The liquid hose 16 thus is in communication with the faucet 10 and the fluid control device 30 and extends from the proximal end 18 to a distal end 20 of the liquid hose 16. The liquid hose 16 can be a hose, pipe, tube, or the like. While not illustrated, it is understood that the liquid inlet 32 can in other arrangements be directly coupled to the outlet 8 of the faucet 10.

The gas or air hose 46 is in communication with the gas (air) supply 40 and the fluid control device 30 and extends from a proximal end 44 to a distal end 48. The gas hose 46 is located between the gas supply 40 and fluid control device 30. The gas supply 40 has a gas supply outlet 42 that is coupled to the proximal end 44 of the gas hose 46. The gas hose 46 has a distal end 48 that is coupled to a gas inlet 34 of the fluid control device 30. The gas hose 46 can be a hose, pipe, tube, or the like.

The fluid control device 30 has a first inlet 32, a second inlet 34, an outlet 36, and a housing 58. The outlet 36 of fluid control device 30 is coupled to a proximal end 52 of an output hose 50. The fluid control device 30 includes passages (discussed below) that are formed of a material that can contain pressurized fluids, such as liquid and air. The passages define flow paths and can be tubing, pipes, hoses, conduit, or the like. The user can command a control input device 38, disposed on the outside of housing 58 in the illustrated embodiment, to obtain a desired output from the fluid control device 30. In other arrangements, the control device 38 can wirelessly communicate with valve-controlling electronics within the housing 58. The inlets 32, 34 and outlet 36 are threaded so that they can be coupled to the hoses 16, 46, 50. In one embodiment, the hoses 16, 50 are conventional garden hoses, the inlet 32 and the outlet 36 having a standard diameter and pitch to receive the threads of hoses 16, 50. In another embodiment, one or both of the hoses 16, 15 are capable of operating at elevated pressures (e.g., at least 1200-1500 psi). Those skilled in the art will recognize that there are a variety of coupling configurations that can be used to connect the inlets 32, 34 to hoses 16, 46 and to connect the outlet 36 to the hose 50. Preferably, the seals formed by the coupling of the inlets 32, 34 to hoses 16, 46 and the outlet 36 to the hose 50 will prevent pressure loss due to leaking.

The output hose 50 is in fluid communication with the fluid control device 30 and the nozzle 22. The output hose 50 is interposed between the ends 52, 54. The distal end 54 of output hose 50 preferably terminates in a nozzle 22, which may be an independent attachment with a nozzle coupler 24. For example, the distal end 54 of the output hose 50 may have external threads of a conventional type that can be received by internal threads of the nozzle coupler 24. Preferably, the seal formed by the distal end 54 and nozzle coupler 24 will not leak fluid, thereby preventing reduction of fluid pressure. The output hose 50 is a conduit that can provide fluid communication between the fluid control device 30 and the nozzle 22, such as a hose, pipe, tube, or the like. In one embodiment, the output hose 50 is a conventional garden hose. In another embodiment, the output hose 50 is a hose capable of operating at elevated pressures (preferably up to 1200-1500 psi, or up to 2000 psi, or up to 2500 psi, or up to 5000 psi).

The nozzle 22 is attached to the distal end of the nozzle coupler 24 and has a nozzle outlet 28 at its distal end. The distal end 54 of the hose 50 or nozzle 22 can be configured to receive other attachments (e.g., a spray gun) or can be a conventional sprayer nozzle having a rotating distal end to control the fluid flow out of the nozzle. Those skilled in the art recognize will that there are a variety of nozzle attachments for various circumstances.

FIG. 1B is a schematic cross-section of the fluid control device 30 in accordance with one embodiment of the present invention. A liquid passage 60, gas passage 62, and fluid mixing chamber 64 are defined within the housing 58. The liquid passage 60 defines a fluid flow path and is positioned at some point between the fluid mixing chamber 64 and the inlet 32. The gas passage 62 defines a second fluid flow path and is positioned between the inlet 34 and the fluid mixing chamber 64. The fluid mixing chamber 64 is sized to hold both liquid from the liquid passage 60 and gas from the gas passage 62. An output passage 78 is positioned between and connects the fluid mixing chamber 64 and the outlet 36. A second or bypass gas passage 68 is positioned between the gas passage 62 and the output passage 78.

The illustrated fluid control device 30 includes a plurality of valves for selecting the flow type. These valves can optionally comprise check valves, allowing flow in the distal direction and blocking flow in the proximal direction. For example, the liquid valve 80 and the gas valve 82 can be check valves that are positioned at some point between the pressure chamber 64 and the inlets 32, 34. Thus, liquid from the proximal side of the liquid valve 80 can pass through the liquid valve 80 located along the liquid passage 60. Liquid or gas that is on the distal side of the liquid valve 80, however, will not be permitted to pass therethrough. Similarly, the gas valve 82 located along the gas passage 62 prevents the flow of gas or liquid back through the valve 82 into the distal end 48 of the gas hose 46. Gas from the proximal side of the gas valve 82 can pass through valve 82 in the distal direction. The control input device 38 (FIG. 1B) commands an outlet valve system 84 so that either gas passes from the bypass gas passage 68 or liquid passes from the fluid mixing chamber 64 into the output passage 78. Further, the control input device 38 may either allow or stop pressurized gas and/or liquid from entering the fluid mixing chamber 64 by controlling the liquid check valve 80 and gas check valve 82. The user can use the control input device 38 to allow gas flow from the gas passage 68 to pass through outlet valve system 84 into the output passage 78 and inhibit liquid flow through valve system 84. Alternatively, the user can use the control input device 38 to allow pressurized or unpressurized liquid flow from the fluid mixing chamber 64 to pass through outlet valve system 84 and into output passage 78 and to inhibit gas flow through valve system 84.

FIG. 1C is a schematic cross-section of a fluid control device 30 in accordance with another embodiment of the present invention. A gas passage 100 is located between an outlet valve system 66 and the gas inlet 34. A liquid passage 102 is located between the outlet valve system 66 and the liquid inlet 32. An outlet passage 104 is positioned between the outlet valve system 66 and outlet 36.

The outlet valve system 66 is thus connected to the gas passage 100, the liquid passage 102 and the outlet passage 104. Preferably, the outlet valve system 66 permits flow within the inlet passages 100, 102 to pass into the outlet passage 104. Specifically, the valve system 66 is fed both gas from the gas passage 100 and liquid from the liquid passage 102 and feeds into outlet passage 104 a fluid flow that can be conventional (non-pressurized, e.g., tap water) liquid flow, a pressurized liquid flow or a gas flow. The control input device 38 (FIG. 1C) communicates with the outlet valve system 66 to selectively allow gas flow from the gas passage 100 and/or liquid flow from the liquid passage 102 to pass through the valve system 66 into output passage 104. When mixing flows, the valve system 66 can preferably vary the relative amounts of liquid and gas fed into output passage 104 to ensure proper flow to nozzle 22.

The valve system 66 thus preferably includes a three-way valving system such that fluid can flow from either the gas flow passage 100 or the water flow passage 102, or from both simultaneously. Of course, both flows can be shut off as well. For example, in one embodiment the valve system 66 has two valves. In one embodiment, each of these valves is a solenoid valve that can be actuated electronically or pneumatically and selectively permits or inhibits flow into the output passage 104. In one embodiment, each valve of the two valves can be partially opened in order to achieve an optimal fluid flow (gas/liquid) through the hose 50 and the nozzle 22. Those skilled in the art recognize will that the outlet valve system 66 can comprise any number of different valves. The outlet valve system 66 may have a check valve for preventing liquid flow into the gas passage 100. In one embodiment, the valve system 66 can comprise valves that are manually controlled.

In operation of the embodiment shown in FIG. 1C, and with reference to FIG. 1A, the user that desires pressurized liquid or water flowing from the nozzle 22 can open the faucet 10 by using the manual control 14 and turn ON the gas supply 40. The liquid flows from the outlet 8 through liquid hose 16 and into the fluid control device 30. The gas source 40 causes gas to pass through the gas hose 46 and into the fluid control device 30. The user sets the control input device 38 such that valve system 66 allows both gas and liquid to pass into outlet passage 104. Thus, the fluid (e.g., liquid and gas) can flow through the outlet passage 104, outlet 36, and output hose 50 and can be sprayed out of nozzle 22. If the user desires only gas (air) or only liquid flowing from the nozzle 22, valve system 66 can stop the flow of one fluid (e.g., liquid) and permit the flow of the other fluid (e.g., air), or vice versa. Alternatively, both valves can be closed.

FIG. 1D is a schematic illustration of the valve system of a fluid control device in accordance with another embodiment of the present invention. In this embodiment, the valve system 66 comprises a y-adapter 320 and valves such as ball or globe valves. For example, a gas valve 340 is located between the gas passage 100 and an internal gas channel 322 of the y-adapter 320. A liquid valve 342 is located between the liquid passage 102 and a liquid channel 324 of the y-adapter 320. A y-adapter output channel 326 is located between passages 322, 324 and the outlet passage 104. Channels 322, 324 can simultaneously feed gas and liquid flow into the y-adapter output channel 326 so that the pressurized liquid (gas and liquid) flows through y-adapter channel 326 and into the outlet passage 104. The user can open the valves 340, 342 to permit gas and liquid flow through the valve system 66 and into the output passage 104. Preferably, the user can adjust the valve settings among variable settings to obtain an optimal output gas/liquid flow.

Further, the valve system 66 is preferably capable also of feeding the output passage 104 with an exclusive gas flow or an exclusive liquid flow. The user can inhibit gas flow through the y-adapter 320 by closing the gas valve 340 and permit liquid flow through the y-adapter 320 by opening the liquid valve 342, thereby causing liquid to flow from the y-adapter 320 into the outlet passage 104. Similarly, the user can permit gas flow through the y-adapter 320 by opening the gas valve 340 and inhibit liquid flow through the y-adapter 320 by closing the liquid valve 342, thereby causing gas to flow from the y-adapter 320 into the outlet passage 104. Thus, the valve system 66 can feed the output hose 50 a mixed liquid-gas flow, an exclusive gas flow, or an exclusive liquid flow.

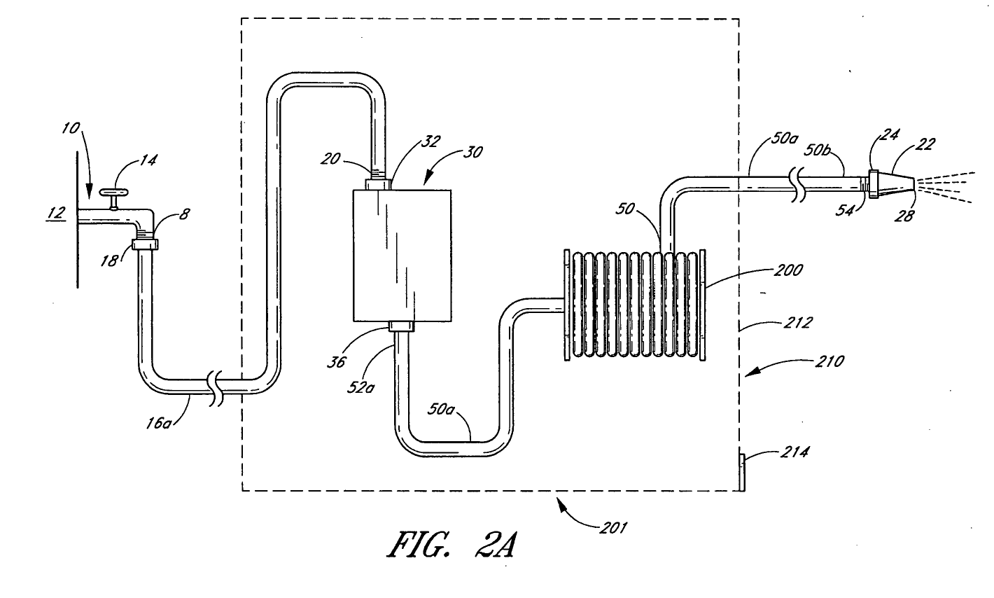

FIG. 2A is a schematic illustration of a hose system 201 having a fluid control device 30 between two lengths of hose in accordance with the another embodiment of the present invention. A liquid hose 16a communicates fluid from the liquid source or faucet 10 to the fluid control device 30. The fluid control device 30 is in fluid communication with a hose reel apparatus 210. The hose reel apparatus 210, in turn, is in fluid communication with the nozzle 22.

In the illustrated embodiment, the hose reel apparatus 210 includes the fluid control device 30 inside a hose reel apparatus housing 212 (represented by dashed lines), although in other arrangements the fluid control device 30 can be connected outside the hose reel apparatus housing 212. A fluid path connection between the fluid control device 30 and a second hose section 50b can be direct, but is preferably conducted via a first hose section 50a. The proximal end 52a of the first hose section 50a connects to the outlet 36, and the distal end 54a of the first hose section 50a connects to the hose reel, where internal passages communicate fluid from the first hose section 50a to the second hose section 50b. A section of the second hose section 50b wraps around the hose reel drum 200 and terminates at the distal end 54 in a hose nozzle 22 or other attachment device, such as spray gun or extension rod (not shown). The hose system 201 can have the fluid control device 30 as described above with respect to the embodiments of FIGS. 1A, 1B, 1C, and 1D.

While not illustrated, it will be understood that the hose reel preferably includes a mechanism to distribute the hose across the surface of the drum as it winds, thereby avoiding tangling and maximizing efficiency. Most preferably, the hose reel apparatus 210 employs a mechanism similar to that disclosed in U.S. Pat. No. 6,422,500 issued to Mead, Jr. on Jul. 23, 2002, and assigned to the assignee of the present application, the disclosure of which is incorporated herein by reference. In particular, that application illustrates at FIGS. 8A and 8B and related text a method of distributing hose across the hose reel drum by relative rotation between a housing shell with a hose aperture and the drum housed within. Mechanisms for linking the rotation of the drum along the horizontal axis and the rotation of the surrounding shell can include the spiral groove as illustrated in the incorporated patent, or can include any of a number of other linkage systems.

FIG. 2B is a schematic cross-section of the fluid control device 30, as shown in FIG. 2A, in accordance with one embodiment. A liquid passage 220 is positioned and defines a fluid flow path between the liquid inlet 32 and an outlet valve system 260. A second liquid passage 222 is located between the liquid passage 220 and a fluid mixing chamber 240. The second liquid passage 222, the first liquid passage 220, and the liquid inlet 32 form a liquid inlet system 400. A pressurized liquid passage 242 is located between the valve system 260 and the fluid mixing chamber 240, although the outlet valve system 260 may be directly connected to the fluid mixing chamber 240. An output passage 262 defines a flow path and is located between the outlet valve system 260 and the outlet 36.

A gas passage 232 is positioned and defines a gas flow path between an air intake 230 and the valve system 260. A second gas passage 234 defines a flow path and is in fluid communication with a gas pressurization device 300 and the fluid mixing chamber 240. A gas inlet system 402 includes the second gas passage 234, the first gas passage 232, the gas pressurization device 300, and the gas inlet 230. In the illustrated embodiment, the second gas passage 234 branches the gas passage 232 and the fluid mixing chamber 240. Alternatively, the second gas passage 234 can be positioned between the gas pressurization device 300 and the fluid mixing chamber 240, such that the distal end of passage 234 is directly connected to the fluid mixing chamber 240. The air intake 230 is disposed at an outside surface of the fluid control device housing 58a and defines a gas flow path between the ambient air outside the housing 58a and the gas pressurization device 300. The gas pressurization device 300 may be a gas (air) compressor, such as a pump, with fixed or variable displacement, that causes the air pressure within gas passage 232 to be greater than the ambient air pressure. Alternatively, the gas pressurize device 300 may be a fan or blower driven by a motor.

The fluid mixing chamber 240 is sized to hold both liquid that is fed from the second liquid passage 222 and compressed gas from the second gas passage 234. In operation, the liquid pressure in chamber 240 may be greater than a regular liquid pressure within liquid passage 220. Although not shown, a valve (e.g., a check valve) is preferably positioned between the fluid mixing chamber 240 and the inlet 32, preferably along the second liquid passage 222. The valve allows liquid flow into the fluid mixing chamber 240 and inhibits liquid and gas flow into the liquid passage 220. Similarly, a check valve can be positioned along the second gas passage 234.

A control input device 214 (shown on the hose reel apparatus housing 212 in FIG. 2A) and the outlet valve system 260 are in electrical communication so that the valve system 260 functions as a 3-way switch that permits flow within one of the passages 220, 242, 232 to pass into output passage 262. The outlet valve system 260 may include any number of valves of different types, such as a liquid valve, pressurized liquid valve, and gas valve. A liquid valve can be positioned between the liquid passage 220 and the output passage 262. A pressurized liquid valve can be positioned between the pressurized liquid passage 242 and the output passage 262. As used herein, a “pressurized liquid valve” refers to a liquid valve capable of withstanding elevated liquid pressure, e.g., 40-5,000 psi. A gas valve can be positioned between the gas passage 232 and the output passage 262. Each of these valves selectively permits or inhibits flow therethrough. Preferably, the control input device 214 can open either the liquid valve, pressurized liquid valve, or gas valve and close the other two valves. Skilled artisans will recognize that the outlet valve system 260 can be a single three-way valve or plurality of independent valves as described above that control liquid/gas flow, and can be actuated electronically, mechanically, or pneumatically. For example, in one embodiment the valve system 260 may comprise three pneumatic solenoid valves, each of the three valves opening and closing one of the passages 220, 232, 242.

In operation of the embodiment shown in FIG. 2A, the hose reel apparatus 210 and the fluid control device 30 can be connected to the liquid source or water faucet 10 and placed at any convenient position. When not in use, the second hose section 50b may be wound upon the hose reel drum 200 with perhaps only the nozzle 22 protruding from the hose reel apparatus housing 212. When the fluid control device 30 is in an off position during non-use, there is no pressure in the second hose section 50b, even though the faucet 10 is open. There is a reduced risk of leakage, at least downstream of the fluid control device 30, and the second hose section 50b readily winds upon the housing reel drum 200 and can be slightly compressed, depending on the nature of the hosing. When it is desired to operate the hose, the user can pull upon the nozzle 22 and freely unwind the hose from the drum 200. In alternative embodiments, the reel drum 200 may by operatively connected to a motor for powered winding and unwinding of the hose 50b.

When the user desires liquid flowing from the nozzle 22, the user can open the faucet by using the manual control 14. The liquid flowing from the outlet 8 of the faucet has the “regular” liquid pressure (e.g., 40 to 60 psi for residential, municipal or county water sources). The liquid from the faucet 10 flows through the liquid hose 16a and into the fluid control device 30. The user can set the control input device 214 so that the fluid control device 30 outputs liquid at regular pressure. In this mode, the liquid flows through the liquid passage 220, the outlet valve system 260, the output passage 262 and into first hose section 50a. The valve system 260 inhibits the flow of pressurized liquid and gas within passages 242, 232. Thus, only the liquid at regular pressure passes into the first hose section 50a.

Alternatively, the user can set the control input device 214 for pressurized liquid. This setting both allows flow through the pressurized liquid passage 242 to the output passage 262 and turns on the gas pressurization device 300. In this mode, the pressurized liquid within the pressurization chamber 240 is at a high pressure (greater than regular liquid pressure) and flows through pressurized passage 242, the valve system 260, the output passage 262 and into the first hose section 50a. The outlet valve system 260 inhibits the flow of liquid at regular pressure (e.g., pressure in the range of about 40 psi to about 60 psi) from liquid passage 220 directly to the output passage 262 and of gas from gas passage 232 directly to the output passage 262. Rather, liquid and gas can flow only through the fluid mixing chamber 240. Thus, only pressurized liquid passes into the first hose section 50a.

Similarly, the user can set the control input device 214 to have the fluid control device 30 output air flow. In this mode, the gas pressurization device 300 is ON and draws air through the air intake 230. Air passes through gas passage 232 and valve system 260, while the valve system 260 inhibits the flow of liquid from passages 220, 242 such that only gas flows through output passage 262 and into the first hose section 50a.

The fluid (i.e., liquid at regular pressure, pressurized liquid, or gas) passes through the first hose section 50a and the second hose section 50b. Then the fluid passes through the nozzle coupler 24 and out the nozzle outlet 28 of the nozzle 22 as a spray. Differently configured nozzles may be attached to the hose 50b for spraying. Advantageously, the user can choose to spray either gas, ordinary household water flow or pressurized liquid depending on various applications. The fluid flow can be changed from liquid to gas or vice versa through the control input device 214.

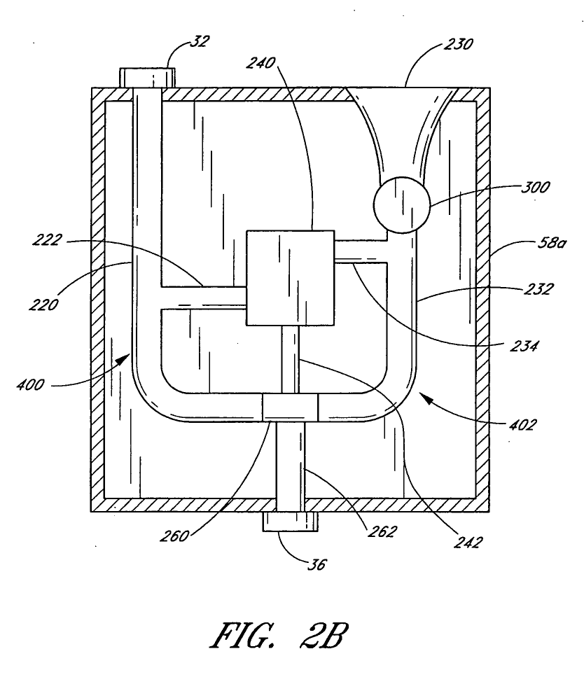

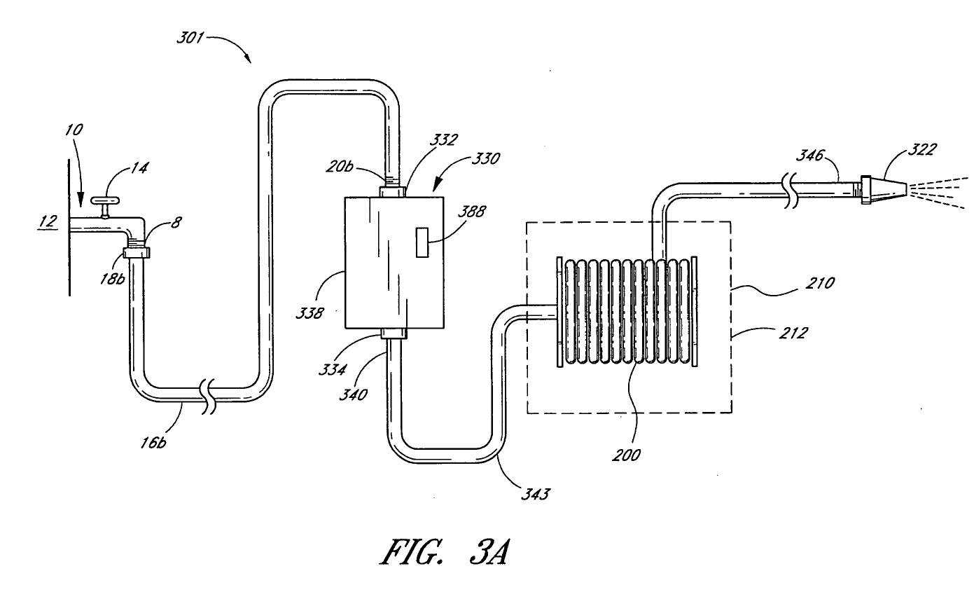

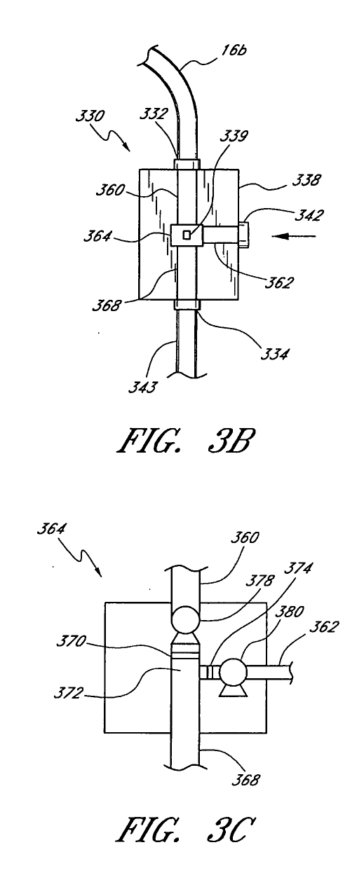

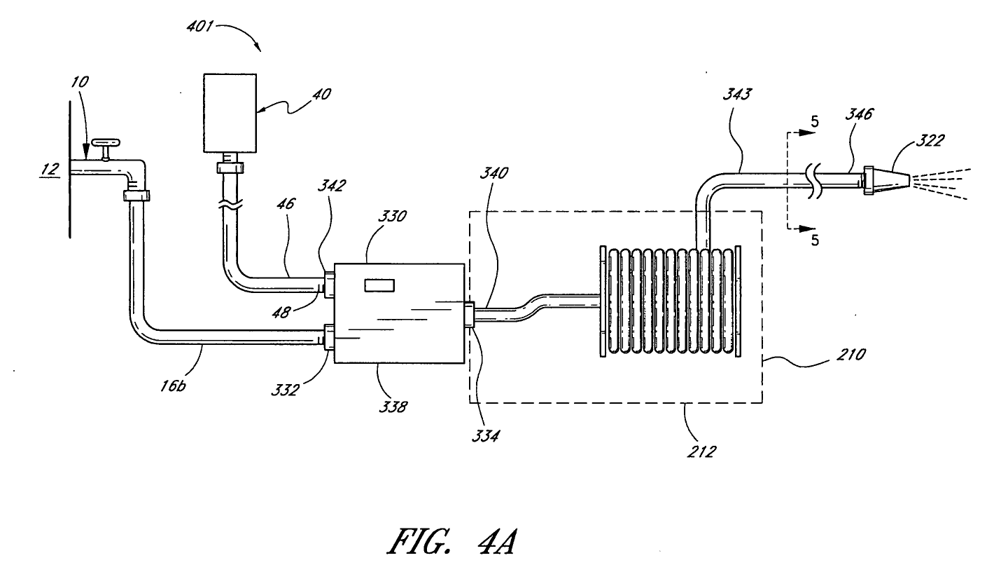

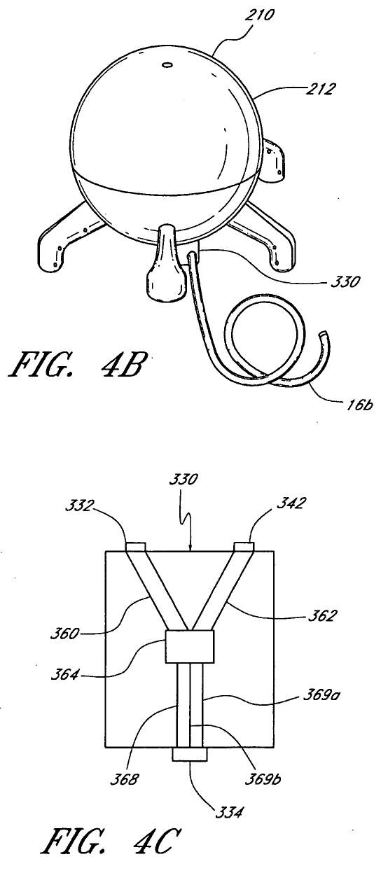

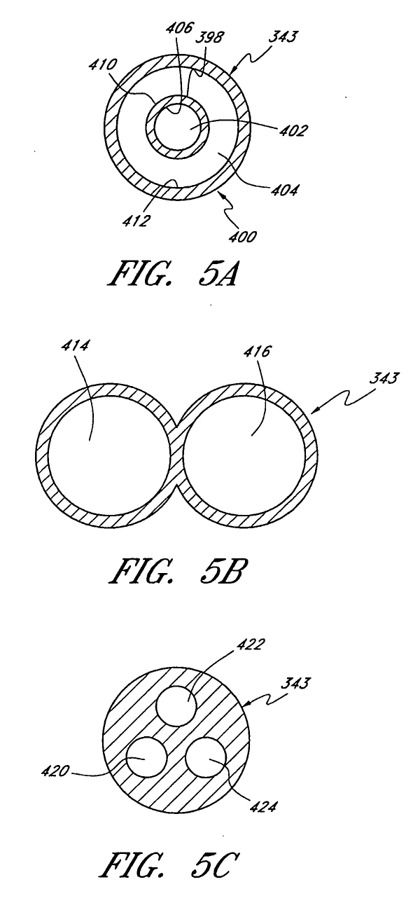

FIG. 3A is a schematic illustration of a hose system 301 in accordance with another embodiment of the present invention. A liquid hose 16b communicates fluid from the liquid source or faucet 10 to a fluid control device 330. The fluid control device 330 is in fluid communication with the hose reel apparatus 210, which, in turn, is in fluid communication with a fluid device 322. The fluid control device 330 preferably provides high pressure fluid to the fluid device 322, which is preferably a high pressure device, such as a high pressure sprayer or nozzle.

In the illustrated embodiment, the faucet 10 provides liquid at a regular or low pressure (e.g., about 40 to about 60 psi). The faucet 10 delivers this low pressure liquid to the proximal end 18b of the liquid hose 16b. A distal end 20b of the liquid hose 16b is preferably configured and coupled to a liquid inlet 332 of the fluid control device 330. The liquid hose 16b thus is in fluid communication with the faucet 10 and the fluid control device 330 and extends from the proximal end 18b to the distal end 20b. The liquid hose 16b can be a hose, pipe, tube or the like. In the illustrated embodiment, for example, the liquid hose 16b has a diameter in the range of about 1/2 inch to about 3/4 inch. In one arrangement, the liquid hose has a diameter of about 5/8 inch, which is fairly standard size for garden hoses. However, the liquid hose 16b can have any diameter suitable for delivering liquid from the faucet 10 to the fluid control device 330. In another embodiment, for example, the liquid hose 16b has a diameter of about 1 inch. One of ordinary skill in the art can determine the appropriate type and size of hose 16b that will achieve the desired flow to the fluid control device 330.

The fluid control device 330 has the inlet 332, an outlet 334, and a housing 338 and is positioned at some point between the nozzle faucet 10 and the nozzle 322. The fluid control device 330 can define a fluid flow path between the inlet 332 and the outlet 334. The inlet 332 of the fluid control device 330 is coupled to the distal end 20b of the liquid hose 16b. The outlet 334 of the fluid control device 330 is coupled to a proximal end 340 of an output hose 343.

In the illustrated embodiment, the fluid control device 330 is a pressure generator or pump which can control the pressure of the fluid delivered to the output hose 343. The fluid control device 330 is preferably a pump which can achieve the desired delivery pressure to the output hose 343 and nozzle 322. For example, the fluid control device 330 can be a centrifugal pump, reciprocating pump (e.g., single piston pump or a radial piston pump), propeller pump, or any other suitable device for delivering the fluid at the desired pressure to the nozzle 322. For example, the fluid control device 330 can be a high pressure, low volume pump for providing fluid at a generally high pressure and low flow rate to the nozzle 322. The fluid control device 330 thus can receive liquid at a first pressure from the liquid hose 16b and provide the liquid at a second pressure to the output hose 343. In one embodiment, for example, the fluid control device 330 can receive liquid at a low pressure from the hose 16b and deliver high pressure liquid out of the outlet 334 of the fluid control device 330 and into the proximal end 340 of the output hose 343. The second pressure is preferably significantly higher than the first pressure. The output hose 343, in turn, provides the high pressure liquid to the nozzle 322. In one embodiment, the fluid control device 330 is a pump adapted for both high pressure and low flow rates. However, the pump 330 can be any pump suitable for delivering fluid at the desired parameters (pressure, flow rate, and the like). The fluid control device 330 thus can provide fluid flow in a range of pressures and flow rates as described herein.

The fluid control device 330 can have a control input device 388 to obtain the desired output from the fluid control device 330. The user can command the control input device 388 to obtain, e.g., the desired flow rate of fluid sprayed from the nozzle 322. The control input device 388 can be used to set, for example, a relative pressure change between the upstream fluid (e.g., the liquid in the hose 16b) and the downstream fluid (e.g., the liquid in the output hose 343) or an absolute pressure of the fluid flow. In one embodiment, the control input device 388 can be used to control a relative pressure change so that the fluid control device 330 receives fluid at a first pressure from the hose 16b and provides liquid at a second pressure greater or less than the first pressure by a desired amount. For example, the user can control the fluid control device 330 to obtain a relative pressure increase of 20 psi. The fluid control device 330 thus can receive liquid at low pressure (e.g., 60 psi) and output liquid at higher pressure (e.g., 80 psi). Alternatively, the user can control the fluid control device 330 to obtain fluid at an absolute pressure. For example, the fluid control device 330 can receive liquid at various pressures, preferably in the range of about 40 psi to about 60 psi, and output liquid at an absolute pressure (e.g., a pressure of about 1,500 psi). The control input device 388 can be similar or different than the control input 38 as discussed herein. Additionally, in some embodiments the fluid control device 330 can deliver a plurality of different fluid flows to the output hose 343 as described herein.

In the illustrated embodiment, the control input device 388 is disposed on the housing 338. Alternatively, the control input device can be in the form of a remote control as described in the co-pending application Ser. No. 10/799,362 entitled REMOTE CONTROL FOR HOSE OPERATION, filed on Mar. 12, 2004, which claims priority to the U.S. Provisional Application No. 60/455,229 filed on Mar. 13, 2003, the entire disclosures of both of which are hereby incorporated by reference herein. For example, a remote control can be used to transmit wireless command signals to electronic components of the fluid control device 330, such as wireless receiver and associated circuitry, to thereby control the valve system 364. The remote control can be used to control the flow rate out of the nozzle 322. Additionally, the hose reel apparatus 210 can be motorized and electrically controllable, as disclosed in application Ser. No. 10/799,362, and controllable by a remote control. In a preferred embodiment, the remotely controllable fluid control device 330 and the remotely controllable hose reel apparatus 210 are controlled by a single remote control.

The fluid control device 330 can be in electrical communication with a power supply. In one embodiment, the fluid control device includes a power supply 339 (shown in FIG. 3B), such as a battery, which provides power to electrical components (e.g., pumps or the valves) of the fluid control device. The power supply 339 can be a battery that is preferably disposed within the housing 338 of the fluid control device 330, or in the housing 212 of the hose reel apparatus 210. In one arrangement, the battery is a rechargeable battery that can be connected to and recharged by an AC power supply, such as a typical residential electrical outlet. Alternatively, the fluid control device 330 can be directly powered by an AC power supply. The power supply can provide power to several components of the hose system. For example, the power supply can provide power to a plurality of fluid control devices 330 and/or a flow control unit.

In one embodiment, for example, the fluid control device 330 can deliver a fist fluid (e.g., water) at a first pressure and a second fluid (e.g., air) of a second pressure to a multi-passage hose 343, as described below. The control input device 388 can be used to selectively control the different fluid flows from the fluid control device 330.

The output hose 343 is in fluid communication with the fluid control device 330 and the nozzle 322. The output hose 343 has a proximal end 340 and a distal end 346. The distal end 346 of the output hose 343 preferably terminates in the high pressure nozzle 322. The distal end 346 of the output hose 343 is preferably coupled to the high pressure nozzle 322. The diameter of the output hose 343 is preferably less than or equal to about 1/2 inch. For example, the output hose 343 can be a conventional hose that is configured to be coupled to a high pressure nozzle. In another embodiment, the output hose 343 is a hose capable of operating at elevated pressures (e.g., pressures up to 1200-1500 psi, or up to 2000 psi, or up to 2500 psi, or up to 5000 psi). Further, the output hose 343 can be capable of providing high pressure fluid flows to the nozzle 322. In one embodiment, the output hose 343 is a typical high pressure hose configured to provide fluid flow to a sprayer or nozzle.

The nozzle 322 can be any device suitable for delivering (e.g., spraying) a fluid. In one embodiment, the nozzle 322 is preferably a high pressure nozzle adapted for receiving liquid at a pressure which is significantly higher than the pressure of the fluid delivered by the faucet 10 in the form of a residential water faucet. For example, many typical high pressure nozzles 322 are adapted to spray fluid at a pressure in the range of about 500 psi to 5,000 psi. The liquid at a pressure of about 40 to 60 psi delivered by the faucet 10 thus may not be suitable for operating the high pressure nozzle 322. The low pressure of the liquid can result in a low flow rate out of the nozzle 322 thereby providing undesirable spray from the nozzle 322. The fluid control device 330 can advantageously increase the pressure of the fluid delivered by the faucet 10 to a suitable pressure to operate the high pressure nozzle 322. For example, the fluid control device 330 can receive water at a pressure in the range of about 40 to 60 psi and then pressurize the water sufficiently so that the output hose 343 delivers the water at a high pressure in the range of about 400 psi to about 5,000 psi to the high pressure nozzle 322. In one embodiment, for example, the fluid control device 330 provides liquid at a high pressure of about 500 psi to about 5,000 psi. In another embodiment, the fluid control device 330 provides liquid at a high pressure of at least about 2,000 psi. In yet another embodiment, the fluid control device 330 delivers liquid at a high pressure of at least about 1,200 psi. Thus, the fluid control device 330 can deliver liquid at various pressures suitable for operating different types of high pressure devices. Optionally, the user can use the control input device 388 to control the pressure of the fluid provided by the fluid control device 330.

In operation of the embodiment in FIG. 3A, the user that desires high pressure liquid or water flowing from the high pressure nozzle 322 can open the faucet 10 by using the manual control 14. Liquid flows from the outlet 8 through the liquid hose 16b and into the fluid control device 330.

The fluid control device 330 can pressurize fluid and provide high pressure fluid through the outlet 334 and into the output hose 343. The user can command the control input device 388 to obtain the desired pressure of the fluid provided by the fluid control device 330. In one embodiment, the fluid control device 330 can provide fluid flows at various different pressures. The fluid control device 330 thus can provide fluid flow at different flow rates for certain periods of time. For example, if a user wishes to operate a high pressure device (e.g., nozzle 322) with low pressure water in the range of about 40 psi to about 60 psi, the low pressure water may be inadequate to effectively operate the nozzle 322. For example, the nozzle 322 may operate effectively when it receives a liquid at a pressure of at least 1200 psi. The fluid control device 330 can be conveniently connected to the liquid hose 16b (in the form of either a conventional or high-pressure hose), which is typically connected to the faucet 10. The fluid control device 330 provides liquid at a high pressure to the output hose 343 for effective operation of the nozzle 322.

The fluid control device 330 can also provide fluid at a regular or low pressure to the nozzle 322. In one embodiment, the low pressure flow is generally equal to or slightly greater than the pressure of the water provided by the faucet 10. The diameter of the output hose 343 may be less than the diameter of a conventional garden hose in order to operate as an air hose, as described below. For example, the output hose 343 may have a diameter of about 1/2 inch or less and the hose 16b may have a diameter of about 5/8 inch. The fluid control device 330 can output liquid at a pressure greater than the pressure of the fluid within the liquid hose 16b so that the volume flow rate (i.e., volumetric flow rate) through the output hose 343 is similar to the volume flow rate that would be produced if only the conventionally sized, large diameter hose 16b was connected to the faucet 10 (i.e., without the device 330 and remaining downstream apparatus). The fluid control device 330 can preferably increase or decrease the pressure of the liquid it outputs for decreased or increased cross sectional area, respectively, of the output hose 343. One of ordinary skill in the art can determine the desired pressure provided by the fluid control device 330 depending on, for example, the density of the working fluid and the desired flow rates. For example, the output hose 343 may be adapted for high pressure fluid flows (e.g., flows at about 500 psi to about 1500 psi). These high pressure hoses have a diameter that is less than or equal to about 1/2 inch. Thus, the fluid control device 330 can slightly pressurizes liquid it receives at a “regular” liquid flow to maintain a desirable flow rate. In one embodiment, the fluid control device 330 is configured to operate at a first level and at a second level. When the fluid control device 330 operates at the second level the fluid control device receives a liqiud at a first pressure from the liquid hose 16b and pressurizes the liquid to a second pressure based on the difference between the cross-sectional area of the hose 16b and the cross sectional area of the output hose 343. Preferably, the fluid control device 330 can be operable at the second level to create a volumetric flow rate through output hose 343 that is similar to the volumetric flow rate through hose 16b at a regular volumetric flow rate. The regular volumetric flow rate can be the same or different than the flow rate in a hose which is receiving water from a residential water source providing water in the range of about 40 psi to about 60 psi. Additionally, the fluid control device 330 can be operable at the first level to create a volumetric flow rate suitable for a high pressure device.

In one arrangement, the fluid control device 330 is configured to receive liquid from the inlet 332 at a first pressure and convey the liquid to the outlet 334 at one of a second and a third pressure. The first pressure can be less than the second and third pressures, and the second pressure can be less than the third pressure. The second pressure can be at about a level sufficient to induce a flow rate in the output hose 343 that is generally equivalent to a flow rate of a similar liquid flowing at said first pressure in a lumen having said first cross sectional area, the third pressure may be at least 500 psi.

Additionally, the fluid control device 330 can preferably also permit the fluid from the liquid hose 16b to flow into the output hose 343 without a substantial pressure change (e.g., unpressurized fluid). The fluid control device 330 thus can provide any desired flow rate to the nozzle 322. In one embodiment, the fluid control device 330 is adapted to attach to hose reel apparatus housing 212. In another embodiment, the fluid control device 330 is not attached to the hose reel apparatus housing 212.

The fluid flow, preferably at a high pressure, from the fluid control device 330 can flow through the output hose 343, which is wound around the hose reel apparatus 210 and out of the distal end 346 of the output hose 343 to the nozzle 322. The nozzle 322 can, in turn, spray out the fluid.

FIG. 3B is a schematic cross section of the fluid control device 330 in accordance with one embodiment of the present invention. The fluid control device 330 can receive at least two fluid flows and provide at least one fluid flow to the output hose 343.

In the illustrated embodiment, the fluid control device 330 includes a liquid passage 360, a gas passage 362, a valve system 364, and an output passage 368 which are preferably disposed within the housing 338. The liquid passage 360 defines a fluid flow path and is positioned at some point between the liquid inlet 332 and the valve system 364. The gas passage 362 defines a second fluid flow path and is positioned between an inlet 342 and the valve system 364. The valve system 364 is configured to receive liquid (e.g., water) from the liquid passage 360 and gas (e.g., air) from the gas passage 362 and provide liquid, gas, and mixtures thereof to the output passage 368. The output passage 368 defines a fluid flow path and is positioned between the valve system 364 and the outlet 334, which is adapted to be in fluid communication with the output hose 343.

The valve system 364 can selectively output fluid flow to the output hose 343. In the illustrated embodiment, the valve system 364 includes a two-way valving system such that fluid can flow from the liquid passage 360, the gas passage 362, or from both simultaneously and into the output passage 368. Of course, both of the flows can be shut off as well to stop the fluid flow to the output passage 368. Furthermore, the valve system 364 can include a pressure generator or pump which can pressurize so that pressurized fluid is provided to the output hose 343. Furthermore, the valve system 364 can be similar to the valve systems described herein. For example, the valve system 364 can be similar to the valve system 66. Of course, the valve system 66 can be modified depending on the pressure provided by the fluid control device 330.

FIG. 3C is a schematic cross section of the valve system 364 of FIG. 3B in accordance with one embodiment of the present invention. In the illustrated embodiment, the valve system 364 includes a plurality of valves and a pump or compressor that can pressurize fluid that is delivered to the output hose 343. The valve system 364 has two valves, each of which selectively permits or inhibits flow into the output passage 368. In one embodiment, valves 370, 374 preferably allow fluid flow in the distal direction and can inhibit or prevent fluid flow in the proximal direction. In the illustrated embodiment, the valve 370 is positioned at some point upstream of a proximal end 372 of the output passage 368. The gas valve 374 is positioned at some point along the gas passage 362 that is upstream of the proximal end 372 of the output passage 368. Additionally, the valves 370, 374 can each comprise any number of valves. In one embodiment, for example, each of the valves 370, 374 includes a solenoid valve and check valve. The check valve can ensure unidirectional flow of fluid through at least one of the passages of the valve system 364.

The valve system 364 can include a plurality of compressors or pumps. In the illustrated embodiment, a pump 378 is preferably upstream of the proximal end 372 of the output passage 368 at some point along the liquid passage 360. The pump 378 can increase the pressure of the liquid provided by the liquid passage 360. For example, the pump 378 can receive liquid at a pressure of about 40 psi to 60 psi and provide liquid at a pressure of about 500 psi to about 5,000 psi to the passage 368. Of course, the valve 370 is preferably a high pressure valve that can withstand fluid pressures up to, in one embodiment, about 5,000 psi.

In the illustrated embodiment, a pump 380 is preferably upstream of the proximal end 372 of the passage 368 and can draw ambient air outside of the housing 338 through the inlet 342 (shown in FIG. 3B) and through the passage 362. The pump 380 can provide air flow through the passage 362 and the valve 374 to the proximal end 372 of the output passage 368. Thus, both pumps 378, 380 can provide fluid to the proximal end 372 of the output passage 368 such that their respective fluids can pass either alone or in combination through the output passage 368 and to the output hose 343. One of ordinary skill in the art can determine the appropriate combination of pumps 378, 380 and valves 370, 374 to achieve the desired flow to the output hose 343. Although not illustrated, the proximal end 340 of the output hose 343 can be directly connected to the valve system 364.

In the illustrated embodiment, the control input device 388 of control device 330 commands the valve system 364. The valve system 364 can be in communication with the control input device 388 such that a user can selectively control the flow rate, type of flow (e.g., a liquid flow, gas flow, or mixture thereof), pressure of the fluid flows, and/or other parameters of the fluid flow to the output hose 343. The user thus uses the control input device 388 to allow liquid, gas, or mixtures thereof to flow from the fluid control device 330 and through the output hose 343 and the nozzle 322. In one embodiment, the control input device 388 is disposed on the housing 338. Alternatively, the control input device can be in the form of a remote control as described in co-pending application Ser. No. 10/799,362. For example, a remote control can be used to transmit wireless command signals to electronic components of the fluid control device 330 to thereby control the valve system 364. Additionally, the remote control device can control several components of the hose system. For example, a single remote control device can control the fluid control device 330 and the hose reel apparatus 210. In one embodiment the apparatus 210 is operatively connected to an electronically controllable motor and controllable via remote control as disclosed in co-pending application Ser. No. 10/799,362.

In operation of the embodiment in FIG. 3B, the user that desires liquid (e.g., water) flowing from the high pressure nozzle 322 can open the faucet 10 as described above. Water flows through the liquid hose 16b to the fluid control device 330. The water passes through inlet 332 and through the liquid passage 360 and the valve system 364 and into the output passage 368. The liquid passes through the outlet 334 and the output hose 343 and can be sprayed out of the high pressure nozzle 322. If the user desires a mixed flow of liquid and gas (e.g., a flow comprising water and air), the user can use the control input device 388 to command the valve system 364 so that it allows both air from the passage 362 and liquid from the passage 360 to pass into the output passage 368. The mixture can then flow through the outlet 334, the output hose 343, and can be sprayed out of the nozzle 322. If the user desires only air being sprayed from the nozzle 322, the user sets the control input device 388 such that the valve system 364 allows air to pass through the passage 362 and the valve system 364 and into the output passage 368. The valve system 364 prevents liquid from passing into the output passage 368. Thus, only air flows through the output passage 368, outlet 334, and the output hose 343 and can be sprayed out of the nozzle 322.

FIG. 4A is a schematic illustration of a hose system 401 in accordance with another preferred embodiment of the present invention. The liquid hose 16b provides gas from the liquid source or faucet 10 to the fluid control device 330. The gas supply 40 provides fluid (e.g., pressurized air) to the gas hose 46, which in turn provides the gas to the fluid control device 330. Thus, the water faucet 10 and the gas supply 40 are in fluid communication with the fluid control device 330. The fluid control device 330 is in fluid communication with the hose reel apparatus 210. The hose reel apparatus 210, in turn, is in fluid communication with the nozzle 322. The output hose 343 preferably comprises a first section interconnected between the outlet 334 and the reel drum 200, and a second section interconnected between the real drum 200 and the nozzle 322.

In the illustrated embodiment, the fluid control device 330 is coupled to the hose reel apparatus 210. In one embodiment, the fluid control device 330 has a housing 338 that may be attached directly to the hose reel apparatus housing 212. For example, mechanical fasteners can couple the housing 338 of the fluid control device 330 to the reel apparatus housing 212. The mechanical fasteners can be nut and bolt assemblies, screws, snap fittings, or other suitable coupling devices. For example, the reel apparatus housing 212 can have a bracket or fitting that is configured to engage and hold the fluid control device 330. However, adhesives or other suitable means can be employed for coupling the device 330 to the hose reel apparatus 210.

FIG. 4B is an illustration of the fluid control device 330 (hoses 46 and 343 not shown) of FIG. 4A coupled to the outside of the reel apparatus housing 212. This provides convenient access to the fluid control device 330 for repair and coupling of the hose 16b to the device 330. The outlet or connector 334 (shown in FIG. 4A) can be disposed through the wall of the hose reel apparatus housing 212 and the proximal end 340 of the output hose 343 can be connected to the outlet 334. Alternatively, although not shown, the fluid control device 330 can be disposed within the hose reel apparatus housing 212. For example, mechanical fasteners can couple the fluid control device 330 to the inner surface of the housing 212. Although not illustrated, the fluid control device 330 of FIG. 3A can be attached to the reel apparatus housing 212 in a similar or different manner. Thus, the fluid control device 330 can be connected to the hose reel apparatus 210 via a hose or directly to the housing 212.

FIG. 4C is a schematic illustration of the fluid control device 330 in accordance with another embodiment. The output passage 368 and outlet 334 can be configured to provide fluid flow to an output hose 343 that has a plurality of lumens or passages. For example, the output passage 368 can have a plurality of passages, each passage corresponding to one of a plurality of passages of the output hose 343. In one embodiment, the output passage 368 has a first passage 369a and a second passage 369b. The valve system 364 receives liquid from the liquid passage 360 and provides the liquid to the first passage 369b. The first passage 369b, in turn, provides the liquid to a first passage of the multi-passage output hose 343. The valve system 364 can receive gas from the gas passage 362 and provide the gas to the second passage 369a of the output passage 368. The second passage 369a, in turn, provides the gas to a second passage of the multi-passage output hose 343. The valve system 364 can provide fluid to the first and second passages of the output hose 343 simultaneously or at different times. It is contemplated that the output passage 368 can have co-axial passages, side-by-side passages, or other configurations configured to mate with the output hose 343. Of course, the outlet 334 can alternatively be coupled directly to the valve system 346, without the need for an extended outlet passage 368.

FIG. 5A is a cross sectional view of the output hose 343 along line 5-5 of FIG. 4A. The output hose 343 can have a plurality of passages or lumens. In the illustrated embodiment, for example, the output hose 343 is a coaxial hose that includes a pair of generally concentric tubes or hoses 398, 400, and a plurality of passages 402, 404. The passage 402 is defined by the inner surface 406 of the hose 398. The passage 404 is defined by an outer surface 410 of the hose 398 and an inner surface 412 of the hose 400. Although not illustrated, the output hose 343 can have any number of passages suitable for providing fluid to the nozzle 322. For example, the output hose 343 can be a triaxial hose. Furthermore, the hoses can be in any configuration suitable for providing fluid flow between the fluid control device 330 and the nozzle 322.

In operation, the hose 343 preferably has at least one passage for providing liquid communication between the fluid control device 330 and the nozzle 322. In the embodiment of FIG. 5A, the passage 402 provides liquid between the fluid control device 330 and the nozzle 322. The passage 404 preferably provides gas or a mixture of gas/liquid between fluid control device 330 and the nozzle 322. The passages 402, 404 thus can provide different phase fluids to the nozzle 322. However, the passages 402, 404 can be used to provide same phase fluids. For example, the passage 402 can provide a mixture of water and an additive (e.g., chemicals, surfactants, detergents, and the like) and the passage 404 can provide water to the high pressure nozzle 322. The hoses 398, 400 can be sized to achieve the desired size of the passages 402, 404. One of ordinary skill in the art can determine the appropriate size and configuration of the multi-axial hoses for the desired fluid flow rates to the nozzle 322.

FIG. 5B is a cross sectional view of the another embodiment of the output hose 343 along line 5-5. The output hose 343 can have a plurality of passages or lumens that are side-by-side. In the illustrated embodiment, the output hose 343 has a pair of side-by-side passages 414, 416. However, the output hose 343 can have any number of passages for delivering fluid to the high pressure nozzle 322. It is contemplated that the output hose 343 can have any configuration suitable to provide fluid communication between the fluid control device 330 and the nozzle 322. For example, as shown in FIG. 5C, the output hose 343 has a plurality of passages 420, 422, 424 for passing fluid between the fluid control device 330 and nozzle 322. In the illustrated embodiment, the passages 420, 422, 424 have longitudinal axes that are offset from the longitudinal axis of the output hose 343. The output hose 343 of FIGS. 5B and 5C can provide flows similar to the output hose 343 of FIG. 5A and thus will not be discussed in further detail. The fluid control device 330 and/or the nozzle 322 can be used to control the flow rate in each lumen of the output hose 343.

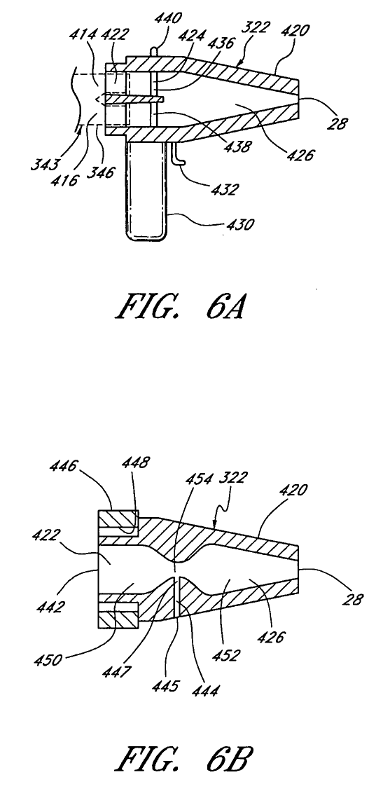

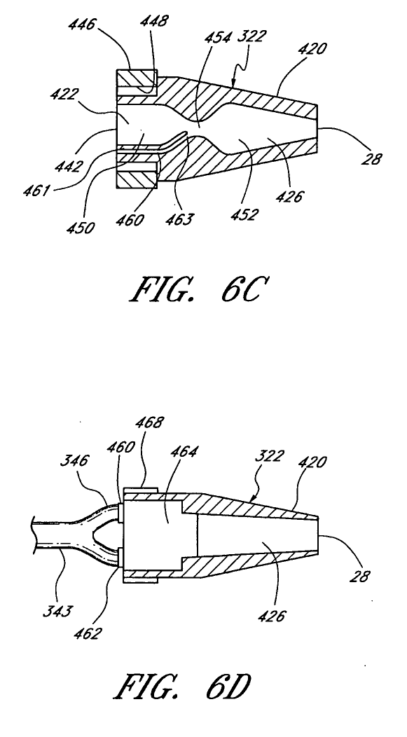

FIG. 6A is a partial cross sectional view of a nozzle for spraying fluid in accordance with a preferred embodiment. The nozzle 322 is configured to mate with the output hose 343 having a plurality of passages. In the illustrated embodiment, the nozzle 322 is a spray gun coupled to the distal end 346 of the output hose 343. Fluid from the fluid control device 330 thus can flow through the output hose 343 and through the outlet 28 of the nozzle 322.

In one embodiment, the nozzle 322 includes a housing 420, an inlet 422, a valve system 424, a chamber 426, and the outlet 28. The inlet 422 is at the proximal end of the housing 420 and the outlet 28 is at the distal end of the housing 420. The housing 420 defines the chamber 426 which provides a flow path between the inlet 422 and the outlet 28. In the illustrated embodiment, the housing 420 includes a hand grip 430 that is configured to be gripped by a user such that the user can engage and actuate a trigger 432 to control the fluid flow out of the nozzle 322. However, the nozzle 322 can have any configuration and size suitable so that the nozzle can be conveniently gripped and held by the user when fluid flows out of the outlet 28.

The inlet 422 is configured to engage the distal end 346 of the output hose 343 so that water can flow into the inlet 422 through the nozzle 322 and out of the outlet 28. The inlet 422 can be permanently or removably coupled to the output hose 343. In one embodiment, for example, the inlet 422 includes fittings that can each be coupled to one of the lumens of the output hose 343 at the distal end 346. The output hose 343 can be frictionally or threadably coupled to the inlet 422. For example, the inner surface of the inlet 422 can define threads that are configured to mate with threads on the outer surface of the end 346 of the hose 343 so that the output hose 343 can be threadably attached to the nozzle 322. Those skilled in the art will recognize that there are many suitable types of connections for coupling the output hose 343 to the nozzle 322. In one embodiment, for example, the nozzle 322 can have a nozzle coupler like nozzle coupler 24 described herein. The valve system 424 can be used to selectively control the fluid flow through the nozzle 322.

In the illustrated embodiment, the valve system 424 includes a pair of valves 436, 438, each of which controls the flow of fluid from one of the lumens of the output hose 343 into the nozzle 322. In the illustrated embodiment, the valve system 424 includes at least one control input device that commands the valves 436, 438. In the illustrated embodiment, the control input device comprises one or more switches 440 that can be actuated so that the valves 436, 438 (e.g., electric or pneumatic solenoid valves) selectively permit or inhibit fluid flow through passages 414, 416, respectively, into the chamber 426. For example, each of the two valves 436, 438 can be partially opened in order to achieve a mixed flow through the nozzle 322. Alternatively, one of the valves 436, 438 can be closed and the other can be opened to permit fluid flow from one of the passages 414, 416 through the nozzle 322. Of course, both flows through the passages 414, 416 can be shut off as well. Thus, the user can control the flow's mixture and flow rates through the nozzle 322 by using the switches 440 conveniently located on the nozzle.

In one embodiment, the switches 440 are used to control whether the flow through the nozzle 322 is from the passage 414, 416, or mixtures thereof. Thus, the switches 440 can be used to open the valve 436 and close the valve 438. Alternatively, the switches 440 can be used to open the valve 438 and close the valve 436. Additionally, the switches 440 can be used to partially open the valves 436, 438. The trigger 432 can be used to control the flow rate through the open or partially open valves of the valve system 424. The user can move the trigger 432 for movement of at least one of the valves 436, 438. Alternatively, the trigger 432 can control an additional valve downstream of the valves 436, 438, which selectively permits or inhibits flow through the nozzle 322. Thus, the switches 440 can determine the type of flow through the nozzle 322 and the trigger 432 can selectively control the flow rate through the nozzle.

The chamber 426 is defined by the inner surface of the housing 420 and provides a flow path between the valve system 424 and the outlet 28. In the illustrated embodiment, the chamber 426 tapers in the distal direction so that the fluid flow rate increases at the distal end of the nozzle 322. However, the chamber 426 can have any suitable shape for delivering fluid to the outlet 28. For example, the chamber 426 can have a shape to promote mixing of the fluids from the passages 414, 416.

FIG. 6B is a cross sectional view of a nozzle in accordance with another embodiment of the present invention. The nozzle 322 includes a proximal end 442, a nozzle coupler or collar 446, the housing 420, the chamber 426, the outlet 28, and one or more passages 444. In operation, the passage 444 draws ambient air into the nozzle 322 via venturi effect. The nozzle 322 combines the ambient air that passes through the passages 444 with fluid flowing from the output hose 343 (not shown). The mixed flow can flow through at least a portion of the chamber 426 and out of the outlet 28 of the nozzle 322. It is expected that the introduction of ambient air via the passage 444 will advantageously produce a finer, more dispersed output spray from the nozzle 322. Skilled artisans will appreciate that the quality of the output spray can be adjusted by varying the size and number of passages 444 in the nozzle 322.

The distal end 346 of the output hose 343 can be coupled to the proximal end 442 of the nozzle 322, such that the distal end 346 is disposed between the collar 446 and the proximal end of the housing 420. In one embodiment, the distal end 346 of the hose 343 has threads configured to mate and threadably engage with threads 448 of the collar 446. However, the collar 446 can have any structures suitable for receiving and coupling the distal end 346 of the output hose 343.

The chamber 426 can be configured to enhance mixture of fluid from the output hose 343 and fluid from another source. In the illustrated embodiment, the chamber 426 promotes mixture of liquid from the output hose 343 and gas, preferably ambient air, from the environment surrounding the nozzle 322. In one embodiment, the chamber 426 can comprise an elongated chamber wherein a portion of the chamber 426 has a reduced cross-sectional area. In the illustrated embodiment, the chamber 426 includes a proximal chamber 450, a distal chamber 452, and a passage 454 having a reduced cross-section therebetween. The passage 454 can produce a high flow rate between the chambers 450, 452. Ambient air is preferably drawn into inlet 445 of the passage 444 and out of outlet 447 and into the passage 454 such that the fluid flow provided by the chamber 450 and the air flow from the passages 444 are combined and fed to the chamber 452. The mixed flow can be agitated within the chamber 452 and then sprayed out of the outlet 28. The mixed flow comprising liquid (e.g., water) and gas (e.g., air) can increase the spraying action of the fluid sprayed out of the outlet 28. Preferably, the nozzle 322 is coupled to the output hose 343 having a single passage. However, the nozzle 322 can be coupled to the multi-passage output hose 343. Although not illustrated, the nozzle 322 can have one or more switches or a control devices, as described herein, for controlling the fluid flow through the nozzle 322.

FIG. 6C is a cross-section view of a nozzle in accordance with another embodiment of the present invention. The nozzle 322 is generally similar to the nozzle 322 of FIG. 6B. However, the nozzle 322 of FIG. 6C has a passage 460 having an inlet 461 and outlet 463. The passage 460 defines a fluid path between the distal end 346 of the output hose 343 (not shown) and the passage 454. For example, the inlet 461 can receive fluid from a passage of the multi-passage output hose 343 and the inlet 422 can receive fluid from another passage of the multi-passage output hose 343. The output hose 343 can thus deliver two separate flows (e.g., liquid and gas flow) to the inlet 422 and the passage 460. These two flows can then be mixed within the chamber 452 and the mixture can flow out of the outlet 28. Preferably, the flow provided by the chamber 450 and the passage 460 are combined within the narrow passage 454 so that mixing occurs at higher flow velocities. Although not illustrated, the nozzle 322 can have a control device, such as one or more switches, to permit or inhibit at least one of the fluid flows through the nozzle. Of course, the hose reel 210 can have a device to control the fluid flow as described herein. Alternatively, the fluid control device 330 can have a control input device, such as control input device 388 of FIG. 3A, that can control the fluid flow through the nozzle 322.

FIG. 6D is a cross-section view of the nozzle 322 in accordance with the another embodiment of the present invention. The nozzle 322 can include a pair of inlets 460, 462, a valve system 464, a chamber 426, and housing 420. The nozzle 322 can be generally similar to the nozzles described herein. However, the nozzle 322 of FIG. 6D can be coupled to the output hose 343 having a pair of tubes at its distal end 346. Each of the ends 346 can be coupled to corresponding inlets 460, 462. Fluid from the hose 343 can be delivered through the distal end 346 through the inlets 460, 462 and to the valve system 464. The valve system 464 can be similar to the valve systems disclosed herein to selectively permit or inhibit flow from the output hose 343 through the nozzle 322. Although not illustrated, the output hose 343 can alternatively be a triaxial hose that terminates into three separate hoses at its distal end 346 coupled to the nozzle 322. The valve system 464 thus can permit or inhibit flow from any number of hoses of the output hose 343 through the nozzle 322 and out of the outlet 28. The valve system 464 can also have one or more controllers or switches 468 so that the user can control the flow through the nozzle 422.

Although not illustrated, the chamber 426 can have other configuration. In one embodiment, a substantial portion of the chamber 426 has a generally uniform cross sectional area between the inlet 422 and the outlet 28 of the nozzle 322. In another embodiment, a substantial portion of the chamber 426 has a generally uniform cross sectional area and another portion of the chamber 426 has a cross sectional area that is reduced or tapered towards the outlet 28. Additionally, the passages 460, 444 can be located at any point along the nozzle 322. For example, the outlet 463 of the passage 460 (FIG. 6C) can be located at any point along the chamber 426.

It will be appreciated by those skilled in the art that various omissions, additions, and modifications may be made to the methods and structures described above without departure from the scope of the invention. For example, the valve system may have valves that the user manually opens and closes. Further, the methods which are described and illustrated herein is not limited to the exact sequence of acts described, nor is it necessarily limited to the practice of all of the acts set forth. Other sequences of events or acts, or less than all of the events, or simultaneous occurrence of the events, may be utilized in practicing the embodiments of the invention. All such modifications and changes are intended to fall within the scope of the invention, as defined by the appended claims.

1. A hose system comprising:
a fluid control device comprising an inlet and an outlet, the fluid control device configured to receive liquid at a first pressure through the inlet and to provide liquid at a second pressure through the outlet, the first pressure being less than the second pressure; and
a hose reel device in fluid communication with the outlet of the fluid control device, the hose reel device comprising a rotatable drum onto which a hose can be spooled, the hose reel device configured to convey fluid from the outlet to a hose spooled onto the drum.

2. The hose system of claim 1, wherein the inlet of the fluid control device is in fluid communication with a fluid source and the outlet of the fluid control device is in fluid communication with the hose reel device, wherein the hose reel device has a housing to which the fluid control device is attached.

3. The hose system of claim 1, wherein the inlet of the fluid control device is in fluid communication with a fluid source and the outlet of the fluid control device is in fluid communication with a hose that can be spooled onto the rotatable drum of the hose reel device.

4. The hose system of claim 1, wherein the fluid control device comprises a pump configured to pressurize the liquid received at the first pressure so that the second pressure is in the range of about 500 psi to about 5,000 psi.

5. The hose system of claim 1, wherein the fluid control device comprises a pump configured to pressurize the liquid received at the first pressure so that the second pressure is at least about 1,200 psi.

6. The hose system of claim 1, wherein the inlet comprises a liquid inlet, the fluid control device further comprising a gas inlet and a valve system, the valve system configured to allow into the outlet a liquid flow from the liquid inlet while stopping a gas flow from the gas inlet, the valve system configured to allow into the outlet the gas flow from the gas inlet while stopping the liquid flow from the liquid inlet, the valve system configured to allow into the outlet a mixed flow comprising the liquid flow and the gas flow.

7. The hose system of claim 1, further comprising:
an output hose adapted to be spooled around the rotatable drum of the hose reel device and in fluid communication with the outlet of the fluid control device;
an input hose having one end in fluid communication with the inlet of the fluid control device and another end in fluid communication with a liquid source, the input hose having a diameter that is greater than a diameter of the output hose.

8. The hose system of claim 1, wherein the fluid control device further comprises a second inlet, the fluid control device configured to allow into the outlet the liquid from the first inlet while substantially stopping gas from the second inlet, the fluid control device configured to allow into the outlet the gas from the second inlet while substantially stopping liquid from the first inlet.

9. The hose system of claim 8, further comprising a hose that is in fluid communication with the outlet and having a first lumen and a second lumen, wherein the fluid control device and hose are configured so that liquid flows from the fluid control device through the first lumen of the hose and gas flows from the fluid control device through the second lumen of the hose.

10. The hose system of claim 9, wherein the hose has a first end and a second end, the first end being coupled to the outlet of the fluid control device and the second end being coupled to a nozzle configured to selectively receive the liquid and gas flows from the first and second lumens.

11. The hose system of claim 10, wherein the nozzle comprises a nozzle outlet and a nozzle valve system, the nozzle valve system being configured to permit into the nozzle outlet the liquid flow from the first lumen while inhibiting the gas flow from the second lumen, the nozzle valve system configured to permit into the nozzle outlet the gas flow from the second lumen while inhibiting the liquid flow from the first lumen, the nozzle valve system configured to permit into the nozzle outlet a mixed flow comprising the liquid flow and the gas flow.

12. The hose system of claim 10, wherein the nozzle comprises a nozzle outlet, the nozzle being configured output a mixed flow comprising the liquid flow and gas flow from the first and second lumens.

13. The hose system of claim 1, further comprising a nozzle in communication with the hose reel device, the nozzle comprising:
a nozzle inlet;
a gas passage having a gas passage inlet and a gas passage outlet;
a nozzle outlet; and
a chamber defining a flow path between the nozzle inlet and the nozzle outlet, the gas passage outlet being disposed along the flow path, the chamber being configured to combine liquid from the liquid inlet and gas from the gas passage outlet.

14. The hose system of claim 13, wherein the gas passage inlet is open to the atmosphere exterior of the hose system.

15. The hose system of claim 13, further comprising a hose in fluid communication with the outlet of the fluid control device and the nozzle, the hose having a plurality of lumens, one of said lumens being in fluid communication with the gas passage inlet.

16. The hose system of claim 13, wherein the chamber comprises a flow restrictive portion along the flow path.

17. The hose system of claim 16, wherein the gas passage outlet is disposed within the flow restrictive portion of the chamber.

18. A fluid control device for a pressure fluid system, comprising:
a gas inlet;
a liquid inlet configured to be coupled to a hose;
an outlet configured to be coupled to a hose; and
a valve system configured to allow into the outlet a liquid flow from the liquid inlet while stopping a gas flow from the gas inlet, the valve system configured to allow into the outlet the gas flow from the gas inlet while stopping the liquid flow from the liquid inlet, the valve system configured to allow into the outlet a mixed flow comprising the liquid flow and the gas flow.

19. The fluid control device of claim 18, further comprising:
a gas inlet system comprising the gas inlet and an internal gas passage connected to the gas inlet; and
an external gas hose coupled to the gas inlet.

20. The fluid control device of claim 18, further comprising:
a liquid inlet system comprising the liquid inlet and an internal liquid passage connected to the liquid inlet;
an external liquid hose coupled to the liquid inlet; and
an external output hose coupled to the outlet.

21. The fluid control device of claim 18, wherein the valve system is within a single housing, and the gas inlet, the liquid inlet, and the outlet are disposed on the housing and provide fluid communication with the valve system.

22. The fluid control device of claim 18, wherein the valve system is configured to selectively provide the mixed flow ranging between mostly comprising the fluid flow and mostly comprising the gas flow.

23. The fluid control device of claim 18, wherein the liquid flow is water and the gas flow is air.

24. A method of providing fluid flow, comprising:
receiving a liquid flow from a liquid inlet;
receiving a gas flow from a gas inlet;
conveying into an output hose the liquid flow from the liquid inlet while preventing the gas flow from the gas inlet from flowing into the output hose;
conveying into the output hose the gas flow from the gas inlet while preventing the liquid flow from the liquid inlet from flowing into the output hose; and
conveying into the output hose a mixed flow comprising the liquid flow and the gas flow.

25. The method of claim 24, further comprising raising the pressure of the liquid received from the liquid inlet prior to conveying the liquid into the output hose.

26. A hose system comprising:
a fluid control device comprising an inlet and an outlet;
an inlet hose in fluid communication with the inlet, the inlet hose having an inlet hose lumen with a first cross sectional area; and
an output hose in fluid communication with the outlet, the output hose having an output hose lumen with a second cross sectional area being smaller than the first cross sectional area;
wherein the fluid control device is configured to receive liquid from the inlet at a first pressure and convey the liquid to the outlet at one of a second and a third pressure, the first pressure being less than the second and third pressures, the second pressure being less than the third pressure, the second pressure being at about a level sufficient to induce a flow rate in the output hose that is generally equivalent to a flow rate of a similar liquid flowing at said first pressure in a lumen having said first cross sectional area, the third pressure being at least 500 psi.

27. The hose system of claim 26, wherein the fluid control device is a pump.

28. The hose system of claim 26, wherein the third pressure is at least 1200 psi.

29. The hose system of claim 26, wherein the third pressure is within 500-5000 psi.

30. The hose system of claim 26, wherein the third pressure is at least 2000 psi.

31. The hose system of claim 26, wherein the first pressure is within 40-60 psi.

32. The hose system of claim 26, wherein the first cross sectional area is that which exists within a standard hose having a nominally 5/8 inch diameter.

33. The hose system of claim 26, wherein the second cross sectional area is that which exists within a standard hose having a nominally 1/2 inch diameter.

34. The hose system of claim 26, wherein the output hose is connected to a hose reel device comprising a third hose and a rotatable drum onto which the third hose can be spooled, the output hose connected to the hose reel device so as to convey fluid from the output hose to the third hose.
